(19) United States
(12) Patent Application Publication
(10) Pub. No.: US 2004/0226136 A1
(43) Pub. Date: Nov. 18, 2004

(54) Disposable window handle

(76) Inventor: Jason Annes, Chicago, IL (US)

Correspondence Address: Paul J. Nykaza, Esq., WALLENSTEIN & WAGNER, LTD, 53rd Floor, 311 South Wacker Drive, Chicago, IL, 60606-6630, US

(21) Appl. No.: 10/436,874

(22) Filed: May 13, 2003

(51) Int. Cl. E05B 7/00

(52) U.S. Cl. 16/110.1

(57) ABSTRACT

The present invention provides a handle (10) for use during the installation of a casement window assembly (100). The handle (10) is integrally comprised of a post (20) and a lever (60) extending substantially perpendicular from the post (20). The post (20) has a cylindrical receiver (30) with a plurality of splines (50) extending radially inward. The receiver (30) and the splines (50) are adapted to engage a spindle (118) of the window assembly (100). The lever (60) has an internal slot (80) that is adapted to receive a link (130) of the window assembly (100). The lever (60) also has at least one aperture (90) that is adapted to provide visual access of the interaction between the link (130) and the slot (80). Thus, the handle (10) can be used to perform two distinct functions during the installation of the casement window assembly (100).

### TECHNICAL FIELD

The present invention is generally directed to an article for use with a window assembly. More particularly, the present invention relates to a disposable window handle for use during the installation of a casement window assembly.

### BACKGROUND OF THE INVENTION

In general terms, window assemblies include a frame assembly that operably supports a piece of glass. One type of window assembly is a casement window assembly that is often found in commercial and residential applications. A casement window assembly generally includes a frame assembly and a window assembly. The window assembly is operably connected to the frame assembly such that it can be moved between an open position and a closed position. The frame assembly normally includes a rotary device having a spindle. A rotary handle is mated to the spindle. Rotation of the spindle through actuation of the rotary handle moves the window assembly between the open and closed positions.

The frame assembly also includes a lock assembly. The lock assembly includes at least one pin which mates with at least one keeper mounted on the frame assembly. The lock assembly further includes at least one arm coupled to a link which is operably coupled to the pin. Thus, actuation of the arm and the link causes the pin to engage and disengage the keeper, thereby locking and unlocking the window assembly.

Typically, following the installation of casement windows, a finished rotary handle is installed on the spindle, and a finished lock handle is installed on the link. Although there is a need to test the operability of the casement window during various stages of the installation process, the finished handles are often omitted to prevent damage thereto. To verify the installation of the casement window assembly, an installer must unlock the window assembly, fully open the casement window to ensure that it functions properly through its range of motion, close the window, and re-lock the window assembly. During this installation process, temporary handles can be used to minimize damage to the more expensive finished handles. Traditionally, a first temporary handle was used to operate the spindle and the rotary assembly, while a second temporary handle was used to actuate the link and lock assembly. This created the unnecessary problem of an installer needing to utilize two separate temporary handles during installation of the casement window assembly. The use of these two separate tools, in turn, caused the additional problem of unnecessary time being wasted by the installer in alternating between the two temporary handles. Therefore, the efficiency of the installation process was reduced.

The single handle of the present invention is designed to perform the functions of both the temporary rotary handle and the temporary lock handle and solve other related problems.

### SUMMARY OF THE INVENTION

The present invention relates to a handle for use during installation of a casement window assembly. The handle generally comprises a post and a lever extending perpendicular from the lever. The post has a first end and a second end which define a length of the post. The second end of the post includes a base region from which the lever extends. The post further has a receiver in communication with the first end of the post. The receiver has a first end and a second end, which define a length of the receiver. The second end has a well or basin with a depressed central region. The receiver has an inner wall extending between the first end and the second end. The receiver further has an upper region, an intermediate region, and a lower region. The receiver has a plurality of splines extending radially inward from and spaced along the inner wall. The splines are adapted to engage a spindle extending from a base of the rotary assembly. Each spline has a first end and a second end, which define a spline length.

As discussed above, the handle includes a lever that extends from the base region of the post. The lever has a first end and a second end which defines a lever length. The lever further includes a top wall, a bottom wall, and a pair of opposed sidewalls. The lever further has a slot in communication with the first end of the lever. The slot has a first end and a second end which define a sloth length wherein the first end of the slot is in communication with the first end of the lever. The slot is adapted to receive a link extending from the window assembly, which is inserted into the opening of the slot and towards the second end of the slot. The lever further has at least one aperture which is adapted to provide a user with visual guidance during use and operation of the handle.

According to another aspect of the invention, the handle of the present invention is preferably formed of plastic. Typically, the handle is fabricated with an injection molding process. However, the handle can be formed from metal under a number of processes, including casting. Preferably, the post and lever are integrally formed from one piece of plastic to create the handle.

According to yet another aspect of the invention, the handle performs two discrete function during the installation of a casement window assembly. First, the casement window assembly is mounted to a mounting surface. After mounting of the casement window assembly, verification of its operation is necessary. To do such, the handle is used to unlock the casement window assembly by engaging the handle with a link of the lock assembly. Specifically, the elongated link is inserted into or received by the slot in the lever of the handle. In this manner, the lock assembly is moveable between the locked and unlocked positions.

Next, the handle is used to engage the rotary assembly of the casement window assembly by inserting a spindle into the receiver. Specifically, the spindle is inserted into the receiver until the splines of the spindle engage the splines of the receiver. Once there is proper engagement between the receiver and the spindle, the window assembly is then opened relative to frame assembly by rotating the handle. In a similar but reverse fashion, the casement window assembly is then closed and locked. The handle is used to close the window assembly relative to the frame assembly by rotating the spindle and the rotary assembly in the opposite direction of opening. Once closed, the handle is removed from the spindle by disengaging the splines of the spindle from the splines of the receiver. Once removed, the handle is used to lock the casement window assembly. The process of locking of the lock assembly is initiated by inserting the link into the slot in the lever. Insertion of the arm into the slot can be visually monitored through the handle apertures to ensure proper insertion of the link into the slot of the lever. The lock assembly is then actuated by moving the handle in a generally vertical direction so as to lock the casement window assembly. The direction of movement of the arm and handle during locking will be opposite the direction of movement during unlocking the casement window assembly.

According to another aspect of the invention, the handle of the present invention offers many benefits over conventional handles since it performs tasks formerly requiring at least two tools. Unlike conventional handles, the handle of the present invention is provided to perform both aspects of the installation process: (i) lock and unlock the casement window assembly, and (ii) to open and close the window assembly.

### BRIEF DESCRIPTION OF THE DRAWINGS

FIG. 1 is a perspective view of a prior art device having two distinct handles joined by a frangible web;

FIG. 2. is a top perspective view of a handle according to the invention;

FIG. 3. is a bottom perspective view of the handle of FIG. 2;

FIG. 4. is top plan view of the handle of FIG. 2;

FIG. 5. is a cross-sectional view of the handle taken along line 5-5 of FIG. 4;

FIG. 6 is a perspective view of the handle of FIG. 2 and a lock assembly of a casement window assembly;

FIG. 7 is a perspective view of the handle of FIG. 2 installed on the lock assembly of the casement window assembly;

FIG. 8 is an exploded perspective view of the handle of FIG. 2 and a rotary assembly of the casement window assembly;

FIG. 9 is a perspective view of the handle of FIG. 2 installed on the rotary assembly of the casement window assembly; and

FIG. 10 is a front elevation view of a casement window assembly.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

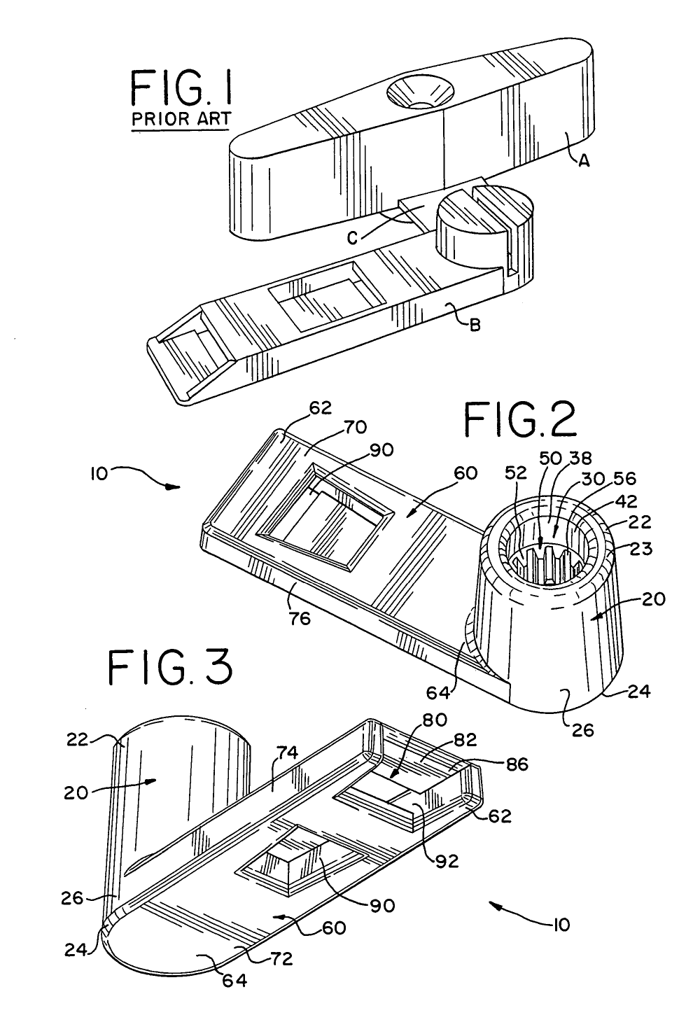

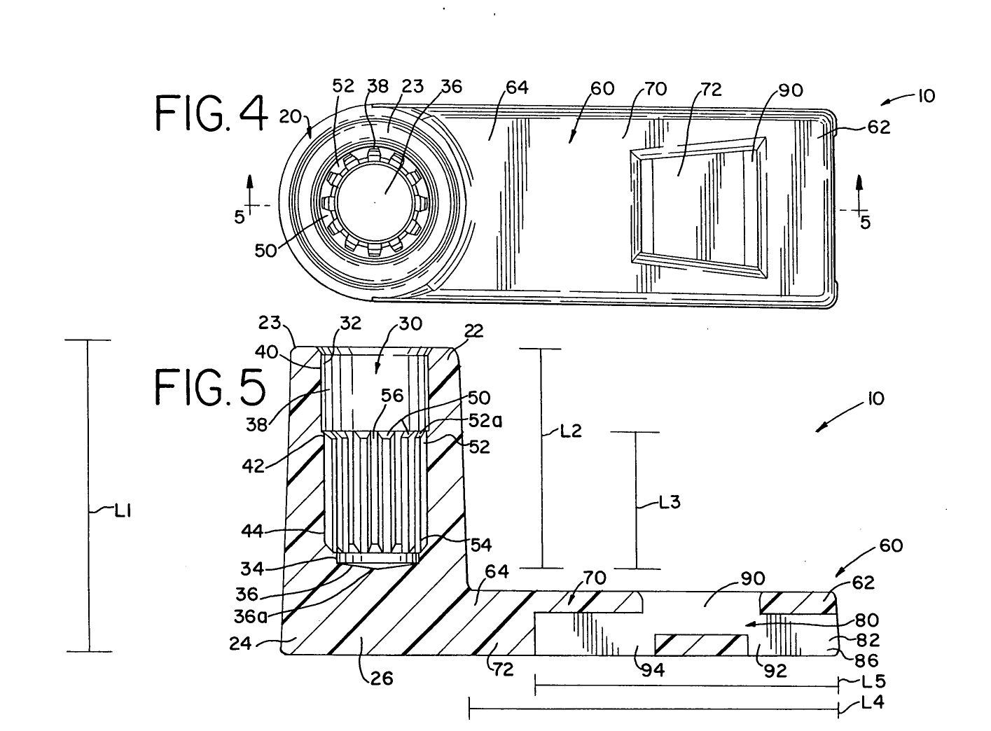

As generally shown in FIGS. 2-5, the handle 10 of the present invention includes a post 20 and a lever 60 extending from the post 20. Preferably, the lever 60 extends generally perpendicular from the lever 60, however, the lever 60 can extend at an angle other than perpendicular. In contrast to the conventional handle assembly shown in FIG. 1 which has two distinct structures A, B joined by a frangible web C, the handle 10 of the present invention is a unitary structure.

The post 20 has a first end 22 and a second end 24. As shown in the figures, the first end 22 has a rounded top wall 23. The post 20 has a length L1 defined by the distance between the first end 22 and the second end 24 (see FIG. 5). The second end 24 of the post 20 includes a base region 26 from which the lever 60 extends. As shown in FIG. 5, the base region 26 of the post 20 is substantially solid and provides the region from which the lever 60 extends. The post 20 further has a receiver 30 in communication with the first end 22 of the post 20. The receiver 30 has a first end 32 and a second end 34, which define a length L2 of the receiver 30 (see FIG. 5). Preferably, the length L2 of the receiver 30 is less than the length L1 of the post 22. Alternatively, the receiver length L2 is equivalent to the post length L1. The second end 34 has a well or basin 36 with a depressed central region 36a. The receiver 30 has an inner wall 38 extending between the first end 32 and the second end 34. The receiver 30 further has an upper region 40, an intermediate region 42, and a lower region 44. Preferably, the inner wall 38 is smooth at the upper region 40. The post 20 and the receiver 30 have a generally cylindrical configuration. However, the configuration of either can vary with the design parameters of the handle 10.

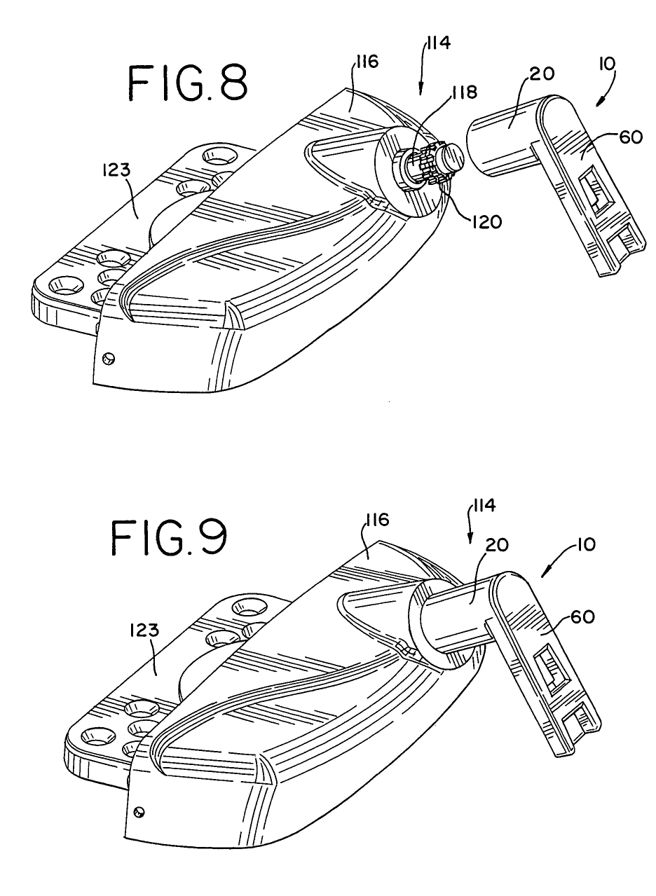

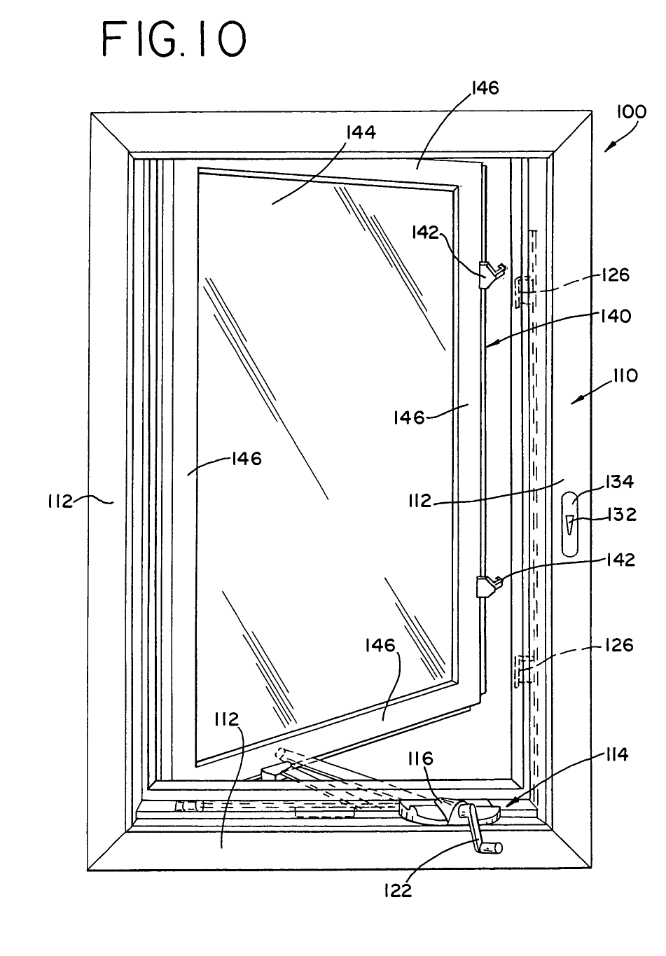

Referring to FIGS. 2, 4 and 5, the receiver 30 has at least one spline 50 extending radially inward from and spaced along the inner wall 38. In general terms, the splines 50 are raised structures when compared to the inner wall 38 of the receiver 30. The splines 50 are generally positioned between the intermediate region 42 and the lower region 44. The splines 50 are adapted to engage a spindle 118 extending from a base 116 of the rotary assembly 114 (see FIGS. 8 and 9). Each spline 50 has a first end 52 and a second end 54, which define a spline length L3 (see FIG. 5). Preferably, the spline length L3 is less than the receiver length L2. Alternatively, the spline length L3 is equivalent to the receiver length L2. In this scenario, the upper region 40 has splines 50 and no longer has a generally smooth interior wall 38. It is understood that the spline length L3 varies with the design of the handle 10. Preferably, the first end 52 of the spline 50 is in communication with the intermediate region 42 of the receiver 30. Also, the second end 54 of the spline 50 is in communication with the well 36 of the second end 34 of the receiver. Since the splines 50 are raised structures, a valley 56 is positioned between a pair of splines 50. Preferably, the first ends 52 of the splines 50 are chamfered to facilitate easier operation of the handle 10. This means that the first end 52 has a ramped or inclined surface 52a which leads towards the second end 54. Although the splines 50 are shown as being continuous, they can have a discontinuous or segmented configuration.

As shown in FIG. 5, the length L2 of the receiver 30 is configured such that the second end 34 of the receiver 30 is spaced a distance from the base region 26 of the post 20. As a result, the well 36 of the second end 34 is spaced from the base region 26. However, it is understood that the length L2 of the receiver 30 may be configured such that the second end 34 of the receiver 30 is within the base region 26 of the post 20.

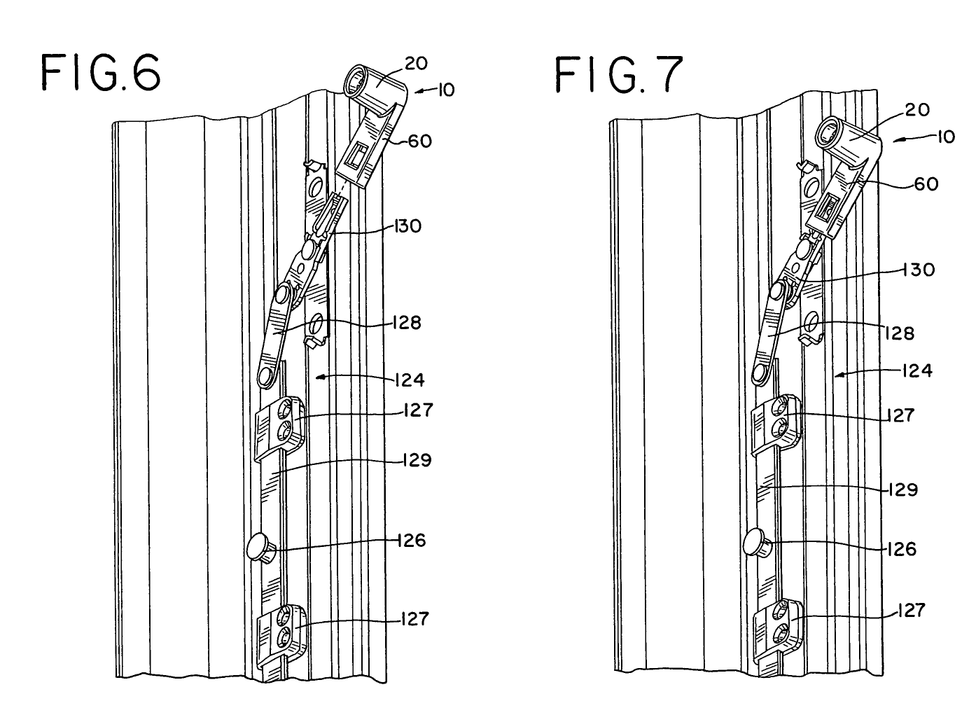

As disclosed above and referring to FIGS. 2-5, the handle 10 includes a lever 60 that extends from the base region 26 of the post 20. The lever 60 has a first end 62 and a second end 64 which defines a lever length L4 (see FIG. 5). The lever 60 further includes a top wall 70, a bottom wall 72, and a pair of opposed sidewalls 74, 76. The sidewalls 74, 76 depend from the top wall 70 and the bottom wall 72 to define the configuration of the lever 60. The lever 60 further has a slot 80 in communication with the first end 62 of the lever 60. The slot 80 represents an internal region or cavity of the lever 60 wherein the slot 80 is bounded by the top wall 70, bottom wall 72 and the sidewalls 74, 76. The slot 80 has a first end 82 and a second end 84 which define a sloth length L5 (see FIG. 5). The first end 82 of the slot 80 is in communication with the first end 62 of the lever 60. Where the first end 82 of the slot 80 meets the first end 62 of the lever 60, an opening 86 in the slot 80 is created. The slot 80 extends internally from the first end 62 of the lever 60 generally towards the second end 64 and/or the post 20. The slot 80 is adapted to receive a link 130 extending from the window assembly 100, which is inserted into the opening 86 of the slot 80 and towards the second end 84 of the slot 80 (see FIGS. 6 and 7). Consequently, the slot 80 is cooperatively dimensioned with at least a portion of the link 130.

Preferably, the length L5 of the slot 80 is less than the length L4 of the lever 60. However, it is understood that the slot length L5 of the slot 80 can be equivalent to the lever length L4 whereby the slot 80 extends from the first end 62 of the lever 60 to the second end 64 of the lever. In such a configuration, the second end 84 of the slot 80 is in communication with the base region 26 of the post 20. Furthermore, it is understood that the slot length L5 can exceed the lever length LA whereby the second end 84 of the slot 80 extends into the base region 26 of the post 20.

The lever 60 further has a plurality of apertures 90, 92, 94 wherein each is adapted to provide a user with visual guidance during use and operation of the handle 10 (see FIGS. 6 and 7). Described in a different manner, the apertures 90, 92, 94 allow the user to see the extent to which the link 130 is received by the slot 80. As shown in FIGS. 2-5, the apertures 90, 92, 94 are positioned in the top wall 70 and the bottom wall 72. Specifically, the top wall 70 has the first aperture 90 and the bottom wall 72 has the second and third apertures 92, 94. The first aperture 90 in the top wall 70 is located between the first end 62 of the lever 60 and the second end 64 of the lever. The second aperture 92 is located in the bottom wall 72 and in communication with the first end 62 of the lever 60. The third aperture 94 is located between the first end 62 and the second end 64 of the lever 60. The precise number and positioning of the apertures 90, 92, 94 varies with the design parameters of the handle 10. Accordingly, the apertures 90, 92, 94 can be positioned in various combinations of the top wall 70, the bottom wall 72, and the side walls 74, 76. Alternatively, the apertures 90, 92, 94 are omitted from the lever 60. In this configuration, the top wall 70, the bottom wall 72, and the side walls 74, 76 of the lever 60 are substantially continuous and uninterrupted. Although the apertures 90, 92, 94 are shown as having a generally trapezoidal configuration, the precise configuration can vary. Also, the configuration of the apertures 90, 92, 94 are not interdependent, meaning that each aperture 90, 92, 94 can have a distinct geometric configuration including square, rectangular, circular, triangular, ovular, or other polygon shape without departing from the spirit of the present invention.

Referring to FIGS. 2-5, the cross-sectional area of the lever 60 is a quadrilateral, preferably a rectangle. However, the cross-sectional area of the lever 60 can take on a variety of different shapes including square, trapezoid, triangular, circular, ovular, or virtually any other polygon. The cross-section of the lever 60 need not be uniform across the lever length L4. Additionally, the area of the cross-section of the lever 60 need not be uniform along the length L4 of the lever 60. For example, the lever 60 can be tapered, wherein the area of the cross-section of the lever 60 increases (or decreases) from the first end 62 of the lever to the second end 64 of the lever. Similarly, the cross-sectional area of the slot 80 is a quadrilateral, preferably a rectangle. However, the cross-sectional area of the slot 80 can assume a variety of different shapes including square, trapezoid, triangular, circular, ovular, or virtually any other polygon. The cross-sectional area of the slot 80 need not be uniform along the slot length L5. For example, the slot 80 is tapered wherein the area of the cross-section of the slot 80 increases (or decreases) from the first end 82 of the slot 80 to the second end 84 of the slot 80. Since the slot 80 is adapted to receive the link 130 of the casement window assembly 100, the slot 80 is cooperatively dimensioned with the geometry of the link 130. Thus, the slot 80 and the portion of the link 130 that is inserted therein share the same geometry. For example, if the slot 80 has a width of approximately 0.5 inches, then the link 130 has a width of approximately 0.5 inches.

The handle 10 of the present invention is preferably formed of plastic. Typically, the handle 10 is fabricated with an injection molding process. However, the handle 10 can be formed from metal under a number of processes, including casting. Preferably, the post 20 and lever 60 are integrally formed from one piece of plastic to create the handle 10. It is also possible for the post 20 and lever 60 to be manufactured separately and then coupled to form the handle 10. In this configuration, either the post 20 or the lever 60 can include means for coupling to facilitate the connection of the two distinct elements.

The handle 10 is intended for use during the installation of a casement window assembly 100. Referring to FIG. 10, the casement window assembly 100 includes a frame assembly 110 and a window assembly 140. The frame assembly 110 includes a plurality of horizontal and vertical frame members 112. The window assembly 140 is shown having two latches or keepers 142 mounted thereto. The window assembly 140 includes a glass pane 144 supported by a plurality of window frame members 146.

Referring to FIGS. 8-10, the frame assembly 110 further includes a rotary assembly 114. The rotary assembly 114 is adapted to permit an operator to move the window assembly 140 in the frame assembly 110 between an open position and a closed position. The rotary assembly 114 includes a base 116 and a spindle 118 extending outward from the base 116. The spindle 118 is operably linked to the window assembly 140. The spindle 118 further includes an arrangement of splines 120 extending radially outward from the spindle 118. The rotary assembly 114 further includes a finished handle 122 (see FIG. 10) that is mounted on the splines 120 of the spindle 118 after installation of the casement window assembly 100 is complete. Typically, the finished handle 122 is fabricated from metal or high-quality plastic to increase its aesthetic appeal. Rotation of the spindle 118 via the handle 10 or the finished handle 122 operates the rotary assembly 114 to move the window assembly 140 between the open and closed positions. The rotary assembly 114 further includes a mounting or interface plate 123 to facilitate engagement of the rotary assembly 114 with the window assembly 100.

Referring to FIGS. 6, 7 and 10, the frame assembly 110 further includes a lock assembly 124. The lock assembly 124 includes at least one pin 126 extending from a lock bar 129 that is slidably supported by guides 127. The pin 126 is adapted to engage the keeper 142 when the window assembly 110 is in the closed position and as a result, the pin 126 is cooperatively positioned with the keeper 142. Engagement and disengagement of the pin 126 with the keeper 142 is accomplished by an arm 128 operably connected to the pin 126. The lock assembly 124 further includes an elongated link 130 that is coupled to the arm 128. Actuation of the arm 128 via the link 130 engages and disengages the pin 126 with the keeper 142. The link 130 extends past the vertical frame member 112 and a finished handle 132 (see FIG. 10) is secured to the link 130 after the window assembly 100 is installed. Like the rotary handle 122 employed after installation of the window assembly 100, the finished handle 132 is a finished piece that increases the aesthetic appearance of the lock assembly 124. The finished handle 132 extends beyond a trim piece 134 that is fastened to a vertical frame member 12 of the frame assembly 110.

When casement windows are delivered to the job site for installation, the casement window assembly 100 is provided without the finished handle 122 attached to the spindle 118. This is done to prevent damage to the finished handle 122 because it is frequently a high-quality, finished element. Similarly, the casement window assembly 100 is typically provided without the finished handle 132 attached to the internal link 130. Again, this is done to prevent any damage to the finished handle 132. Thus, the casement window assembly 100 is frequently installed with the spindle 118 and the internal link 130 exposed and extending from the frame assembly 110. As a result, any potential for damage to either the finished handle 122 or the finished handle 132 during installation is minimized.

During installation, the casement window assembly 100 is mounted to a mounting surface. After mounting of the casement window assembly 100, verification of proper operation of the casement window assembly 100 is necessary. It is necessary to verify that the window assembly 140 opens fully throughout its range of motion within the frame assembly 110 to assure proper operation of the casement window assembly 100. If the casement window assembly 100 is not installed plumb and level to the mounting surface, binding can occur thereby preventing proper operation of the casement window assembly 100.

The handle 10 of the present invention is used to operate the casement window assembly 100 during its installation to verify its proper installation. During an initial stage of installation, the handle 10 is first used to unlock the casement window assembly 100. In general terms, this is done by engaging the handle 10 with the lock assembly 124 by inserting the link 130 into the handle 10. Specifically, a portion of the elongated link 130 is inserted into or received by the slot 80 in the lever 60 of the handle 10. Insertion of the link 130 into the slot 80 can be visually monitored through the three apertures 90, 92, 94 to ensure proper insertion or reception of the link 130. After the link 130 is received by the slot 80, the lock assembly 124, including the arm 128 and the pin 126, are actuated by generally vertical movement of the handle 10. In this manner, the lock assembly 124 is moveable between the locked and unlocked positions.

Once the lock assembly 124 is unlocked, proper operation of the casement window assembly 100 is verified by opening and closing the window assembly 140 relative to the frame assembly 110. The handle 10 is removed from the link 130 by disengaging it from the slot 80. Next, the handle 10 engages the rotary assembly 114 by inserting the spindle 118 into the receiver 30. The spindle 118 is inserted into the receiver 30 until the splines 122 of the spindle 118 engage the splines 50 of the receiver 30. Preferably, the splines 50 of the receiver 30 are cooperatively dimensioned with the splines 122 of the spindle 118 to facilitate engagement between the handle 10 and the rotary assembly 114. Once there is proper engagement between the receiver 30 and the spindle 118, the window assembly 140 is then opened relative to frame assembly 110 by rotating the handle 10 in either a clockwise or counter-clockwise direction. Applying rotational force to the lever 60 causes the spindle 118 to rotate thereby operating the rotary assembly 114 so as to open the window assembly 140 relative to the frame assembly 110.

In a similar but reverse fashion, the casement window assembly 100 is then closed and locked. The handle 10 is used to close the window assembly 140 relative to the frame assembly 110 by rotating the spindle 118 and the rotary assembly 114 in the opposite direction of opening. Once closed, the handle 10 is removed from the spindle 118 by disengaging the splines 122 of the spindle 118 from the splines 50 of the receiver 30. Once removed, the handle 10 is used to lock the casement window assembly 100. The process of locking of the lock assembly 124 is initiated by inserting the link 130 into the slot 80 in the lever 60. Insertion of the link 130 into the slot 80 can be visually monitored through the apertures 90, 92, 94 to ensure proper insertion of the link 130. The lock assembly 124 is then actuated by moving the handle 10 in a generally vertical direction so as to lock the casement window assembly 100. The direction of movement of the link 130 and the handle 10 during locking will be opposite the direction of movement during unlocking the casement window assembly 100.

The handle 10 of the present invention offers many benefits over conventional handles used to install casement window assemblies. One benefit of the present invention is that it provides a handle 10 which can performs tasks formerly requiring at least two tools. Unlike conventional handles, the handle 10 of the present invention is provided to perform both aspects of the installation process: (i) lock and unlock the casement window assembly 100, and (ii) to open and close the window assembly 140. As shown in FIG. 1, conventional handles consist of two distinct structures A and B, joined by a frangible web C, wherein each structure is required to perform an aspect of the installation process. The bulky conventional design provides a first handle B to engage the internal handle 130 in order to lock and unlock the lock assembly 124. Additionally, a second handle A is need to rotatably engage the spindle 118 of the rotary assembly 114 to open and close the window assembly 140. This requires the installer of the casement window assembly 100 to carry and utilize two distinct tools to properly install the casement window assembly 100. The present handle 10 combines the function of the multi-piece conventional design into one, solitary structure. Consequently, fewer parts are needed because the operator can use the single handle 10 of the present invention to install a casement window assembly 100. The handle 10 of the present invention can be distributed by the manufacturer of the casement window assembly 100 such that the handle 10 is used during installation. Thus, a cost savings is realized during manufacturing of the handle 10 where fewer raw materials are conserved in manufacturing one integrated structure instead of two separate structures. This increases the efficiency of the manufacturing process and reduces raw material costs, which in turn can lower the manufacturing cost of the handle 10.

Additionally the handle 10 of the present invention benefits the installer of the casement window assembly 100 in that installation time is reduced through use of a single tool to accomplish the two installation aspects outlined above. An installer using the handle 10 of the present invention is not required to switch tools for the installation aspects, thus increasing the speed and efficiency with which installation can be accomplished. Furthermore, because the handle 10 of the present invention is inexpensive to manufacture, it is disposable. This benefits the installer who need not permanently carry an installation tool, but rather can use the handle 10 packaged with the casement window assembly 100, and dispose of it following installation of all the window assemblies 100 on the job site.

Additional benefits of the handle 10 of the present invention include the ability to install and operate the window assembly 100 without the use of the finished rotary handle 122, the finished lock handle 132, or the trim piece 134. This reduces the likelihood of damage to any of these valuable items. Furthermore, the present handle 10 functions to operate both the lock assembly 124 to lock and unlock the window and the rotary assembly 114 to open and close the window.

While the specific embodiments and various details thereof have been illustrated and described, numerous modifications come to mind without significantly departing from the spirit of the invention and the scope of protection is only limited by the following claims.

I claim:

1. A handle for use in installing a casement window assembly, the handle comprising:
a post having a receiver in communication with a first end of the post, the receiver having an inner wall and a plurality of splines extending radially inward from the inner wall, wherein the splines are adapted to engage a spindle extending from the casement window assembly; and,
a lever extending from the post, the lever having a slot in communication with a first end of the lever, wherein the slot is adapted to receive a link extending from the casement window assembly.

2. The handle of claim 1, wherein the lever extends generally perpendicular from the post.

3. The handle of claim 1, wherein the lever further has at least one aperture providing visual access to the slot.

4. The handle of claim 1, wherein the post and the receiver each have a length, and wherein the length of the receiver is generally equal to the length of the post.

5. The handle of claim 1, wherein the post and the receiver each have a length, and wherein the length of the receiver is less than the length of the post.

6. The handle of claim 1, wherein each of the splines has a first end, wherein the first end is chamfered.

7. The handle of claim 1, wherein the post has a generally cylindrical configuration.

8. The handle of claim 1, wherein the lever has a length and a cross-section generally perpendicular to the length, wherein the cross-section is a quadrilateral.

9. The handle of claim 8, wherein the slot has a length and a cross-section generally perpendicular to the length, wherein the cross-section is a quadrilateral.

10. The handle of claim 9, wherein the area of the cross-section of the slot decreases from a first end of the slot to a second end of the slot.

11. The handle of claim 1, wherein the slot has a length and a cross-section generally perpendicular to the length, wherein the cross-section is a quadrilateral.

12. The handle of claim 1, wherein the lever and the post are integrally formed from plastic.

13. The handle of claim 1, wherein the first end of the post has a rounded top wall.

14. A handle for use in installing a casement window assembly, the handle comprising:
a post having a receiver in communication with a first end of the post, the receiver having an upper region, an intermediate region, and a lower region, the receiver further having a plurality of splines extending radially inward, wherein the splines are positioned between the intermediate region and the lower region, and wherein the splines are adapted to engage a spindle extending from the casement window assembly;
a lever extending generally perpendicular from the post, the lever having a slot in communication with a first end of the lever, wherein the slot is adapted to receive a link extending from the casement window assembly.

15. The handle of claim 14, wherein the lever further has at least one aperture providing visual access to the slot.

16. The handle of claim 14, wherein the upper region has an inner wall with a generally smooth configuration.

17. The handle of claim 14, wherein the upper region and the splines each have a length, and wherein the length of the upper region is less than the length of the splines.

18. The handle of claim 14, wherein the upper region and the splines each have a length, and wherein the length of the upper region is greater than the length of the intermediate region.

19. The handle of claim 14, wherein the upper region and the splines each have a length, and wherein the length of the upper region is generally equal to the length of the splines.

20. The handle of claim 14, wherein the receiver has a length and the splines each have a length, and wherein the length of the splines is less than the length of the receiver.

21. A handle for use in installing a casement window assembly, the handle comprising:
a post having a receiver in communication with a first end of the post, the receiver having an inner wall and a plurality of splines extending radially inward from the inner wall, wherein the splines are adapted to engage a spindle extending from the casement window assembly; and,
a lever extending generally perpendicular from a second end of the post, the lever having an internal slot in communication with a first end of the lever, wherein the slot is adapted to receive a link extending from the casement window assembly.

22. The handle of claim 21, wherein the lever has at least one aperture providing visual access to the slot.

23. The handle of claim 21, wherein the slot and the lever each have a length, and wherein the length of the slot is generally equal to the length of the lever.

24. The handle of claim 21, wherein the slot and the lever each have a length, and wherein the length of the slot is less than the length of the lever.

25. The handle of claim 21, wherein each of the splines has a first end, wherein the first end is chamfered.

26. The handle of claim 21, wherein the post and the receiver each have a length, and wherein the length of the post is greater than the length of the receiver.

27. The handle of claim 26, wherein the splines have a length and wherein the length of the splines is less than the length of the receiver.

28. The handle of claim 21, wherein the post has a generally cylindrical configuration.

29. The handle of claim 21, wherein the receiver has a generally cylindrical configuration.

30. The handle of claim 21, wherein the lever and the post are integrally formed from plastic.
